(19) United States
(12) Patent Application Publication
(10) Pub. No.: US 2004/0192144 A1
(43) Pub. Date: Sep. 30, 2004

(54) Laminose structure cloth with biolysis fiber

(76) Inventor: Cheng-Lin Chuang, Taichung City (TW)

Correspondence Address: BACON & THOMAS, PLLC, 625 SLATERS LANE, FOURTH FLOOR, ALEXANDRIA, VA, 22314

(21) Appl. No.: 10/396,837

(22) Filed: Mar. 26, 2003

(51) Int. Cl. B32B 27/04; B32B 27/12; B32B 5/02; B32B 3/00

(52) U.S. Cl. 442/381; 442/394; 442/392; 442/149

(57) ABSTRACT

The invention relates to a laminose structure cloth with biolysis fiber, compromising an upper layer of biolysis fiber weaved by a yarn made from biolysis PET resin, a middle layer made of the mixture of activated carbon and wet reactive glue, and a lower layer of various cloth or biolysis fiber. In a way of spray painting or dipping, the activated carbon will adhere to the material, and be consolidated with biolysis fiber layer of the upper layer to form a three-layer structure in one process. The product by the invention is characterized in environmental protection and 100% decomposition quickly, and used for manufacturing outerwear, caps, respirators, gloves, shoes, insoles, tablecloth, underwear and brassieres, filter materials, protective garments and socks.

### BACKGOUND OF THE INVENTION

1. Field of the Invention

The invention relates to a laminose structure cloth with biolysis fiber, especially a three-layer structure (biolysis fiber layer, activated carbon mixed glue and fabric) with the characteristics of decomposability and environmental protection.

2. Related Art

Common filter material uses PP fiber or Nylon to make nonwoven fabric. After mixing of activated carbon and resin, the filter material will be formed in dipping method. Its activated carbon has large particles, and fine particles of activated carbon will be overflowed from the surface of the fabric or glue film, which will weaken activation of the activated carbon, resulting in imperfect adsorption and functionality, difficulty in processing, slow production, no environmental protection effect and low activation capability of activated carbon, so that it has such a disadvantage that the waste is impossible to be decomposed and recycled.

### SUMMARY OF THE INVENTION

The invention aims at the above disadvantage and provides a laminose structure cloth with biolysis fiber. Its main object is to provide a three-layer cloth structure, wherein the biolysis fiber layer in single face or a double face is made of high molecular of PET resin with 100% decomposition. The upper layer is of biolysis fiber, weaved into nonwoven cloth or cloth. Then an activated carbon mixed glue layer is formed on the lower layer by spray painting and blends with the biolysis fiber of the upper layer. After being dried, a finished three-layer product will be obtained in one process. It is available in products of nonwoven cloth, fabric, and compound products, with the following characteristics:

1. Easy processing and quick manufacture.

2. Better activation of activated carbon in fabric.

3. Environmental protection.

4. Quick decomposition.

To help the reviewer clearly understand the invention, drawings and brief description of drawings are provided.

### BRIEF DESCRIPTION OF THE DRAWINGS

FIG. 1 is a manufacturing flow chart of the present invention

FIG. 2 is a section view of the three-layer structure cloth of the present invention

### DETAILED DESCRIPTION OF THE PREFERRED EMBODIMENTS

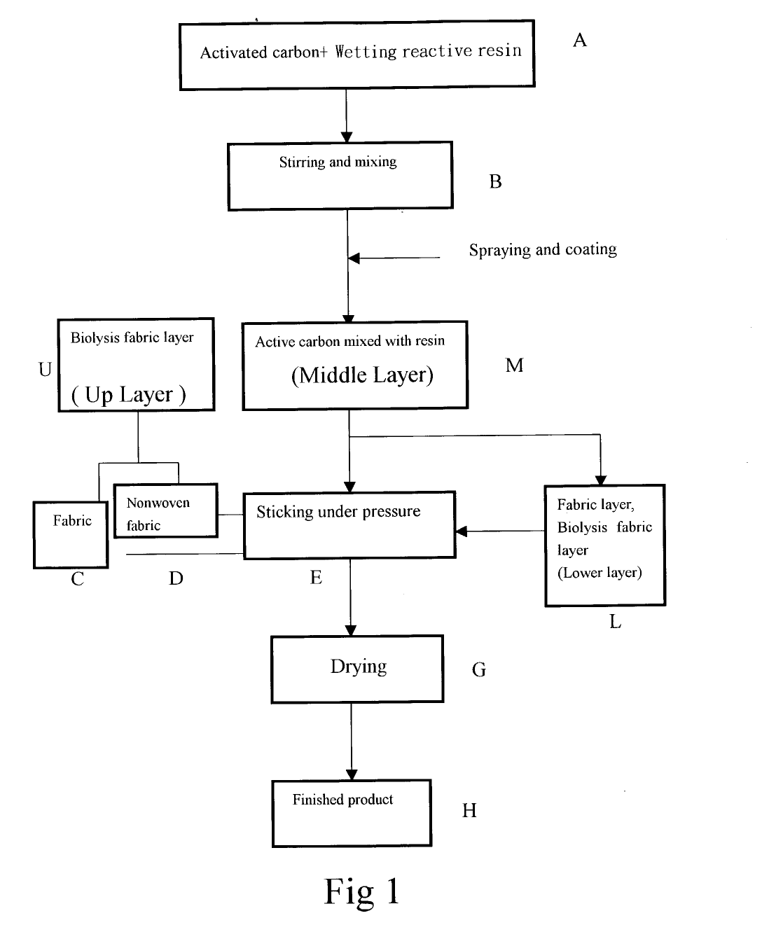

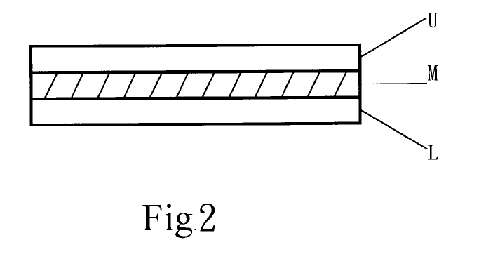

The invention relates to a laminose structure cloth with biolysis fiber 1, as shown in FIG. 1 and 2, it uses a structure of three layers U, M and L, wherein the upper layer U is cloth C or nonwoven cloth D made of biolysis fiber, the middle layer M is activated carbon mixed glue, a mixture of activated carbon and wet reactive glue, and the lower layer L is cloth, nonwoven cloth, nonwoven cloth D made of biolysis fiber or cloth C. Then the three-layer laminose structure cloth 1 with different materials is obtained.

Firstly, referring to FIG. 1 Manufacturing Flow Chart, biolysis yarn is formed with biolysis fiber that is made from biolysis PET resin particles through melting and drawing. And then the yarn is woven into cloth C. In addition, biolysis fiber with a diameter of 5-10 um and length of 5-100 mm is adopted in the following process (1) cotton opening: rotation speed of opening roller 500 rpm, (2) combing: rotation speed of splinter roller 200 rpm, cylinder 400 rpm, working roller 22 rpm, and 18 for doffer, and (3) needling punch: nonwoven D of basic weight 300±10% g/m² is produced, therefore the biolysis fiber of upper layer U will be formed with the nonwoven D. The biolysis fiber layer has characteristics of two-stage biological decomposition and water-added decomposition. Decomposition in the stage occurs when artificial manure is put and produces carbon dioxide and water harmless to soil.

Referring to FIGS. 1 and 2, the mixed resin layer M (middle layer) of activated carbon is formed by stirring and mixing operation B, wherein the biolysis wet reactive glue 10-90% weight percentage mixes with activated carbon 0.1-3% weight percentage, in which the size of activated carbon particles is in nanometer from 10⁻⁹ m to 0.1 m/m. Then the stirring and mixing operation B is carried out to form the mixed glue, which is spray-painted on the middle layer M at the speed of 20-100 g/m². The lower layer is of cloth or biosysis L, on which the glue is spray-painted. The finished product H will be produced in blending process E at a production speed 5-30 yd/min under a blending temperature of 40-120° C., and drying process G.

Referring to FIG. 2, the three-layer structure cloth includes:

(a) The upper layer is biolysis fiber, the lower layer L is fabric, and the middle layer M is mixed glue and activated carbon, those three layers are blended together in a spraying and binding process, referring to FIG. 2.

(b) The upper and the lower layer are biolysis fiber, the mixed glue of activated carbon is the middle layer M, and the three layers are blended together in a spraying and binding process, referring to FIG. 2.

To sum up, the present invention relates to a laminose structure cloth with biolysis fiber, and conforms to the essential elements of new patent application, hereby applying for the patent according to the law.

What is claimed is:

1. A laminose structure cloth with biolysis fiber, including:
(a) an upper layer of biolysis fiber, a lower layer of fabric, and a middle layer of activated carbon mixed glue, while the middle layer is sprayed to the surface of the lower layer and thus blended with the upper layer to form a three-layer structure,
(b) an upper layer and lower layer of biolysis fiber, and the middle layer of activated carbon mixed glue, while the middle layer is sprayed on the surface of the lower layer and thus blended with the upper layer to form a three-layer structure;
The product, characterized in environmental protection and quick decomposition, is available in manufacturing outerwear, caps, respirators, gloves, shoes, insoles, tablecloth, underwear and brassieres, filter material, protective garments and socks.

2. A laminose cloth structure according to claim 1, wherein the biolysis fiber layer is made of PET resin with high melting point, high degree of crystallization and 100% biological decomposition.

3. A laminose cloth structure according to claim 1, wherein the activated carbon mixed glue is the mixture of activated carbon and biolysis reactive glue.

4. A laminose cloth structure according to claim 1, wherein the activated carbon is spray-painted on the surface of the fabric after being ground to certain degree of fineness to achieve a function of anti electromagnetic wave.

5. A laminose cloth structure according to claim 1, wherein material becomes filter material with function of sterilization and efficiency of filtering through anti-static treatment.
